(19) United States
(12) Patent Application Publication
(10) Pub. No.: US 2006/0186563 A1
(43) Pub. Date: Aug. 24, 2006

(54) Method and apparatus for fusing light-shielding sheets respectively onto transparent bodies

(75) Inventors: Sheng-Jui Chao, Tan-Tzu Hsiang (TW); Yi-Long Zhan, Tan-Tzu Hsiang (TW); Hui-Chuan Kuo, Tan-Tzu Hsiang (TW)

Correspondence Address: DLA PIPER RUDNICK GRAY CARY US, LLP, 2000 UNIVERSITY AVENUE, E. PALO ALTO, CA, 94303-2248, US

(73) Assignee: Asia Optical Co., Inc.

(21) Appl. No.: 11/318,229

(22) Filed: Dec. 23, 2005

(30) Foreign Application Priority Data
Feb. 18, 2005 (TW) 094104813

(51) Int. Cl. B29D 11/00

(52) U.S. Cl. 264/1.7; 425/406; 425/394; 425/808

(57) ABSTRACT

An apparatus includes a machine bed, a holder unit disposed movably on the machine bed, and a fusion unit. A method for fusing a light-shielding sheet onto a transparent body includes: (A) moving the transparent body on the machine bed into the holder unit by suction; (B) moving the holder unit on the machine bed in a feeding direction; (C) cooperating with operation of the holder unit so as to move the transparent body on the machine bed to a position under the light-shielding sheet; and (D) pressing together and heating the light-shielding sheet and the transparent body so as to fuse the light-shielding sheet onto the transparent body, thereby forming an optical lens unit.

### CROSS-REFERENCE TO RELATED APPLICATION

This application claims priority of Taiwanese Application No. 094104813, filed on Feb. 18, 2005.

### BACKGROUND OF THE INVENTION

1. Field of the Invention

This invention relates to an optical lens unit, and more particularly to method and apparatus for fusing light-shielding sheets onto transparent bodies.

2. Description of the Related Art

Referring to FIG. 1, in a conventional optical instrument, a light-shielding sheet 2 is disposed between two lenses 1 so as to shield the light outside an effective light-transmissive region of the lens 1.

The light-shielding sheets 2 are made by punching, and have a minimal thickness and a small surface area. The light-shielding sheets 2 are blown one at a time into a net bag (not shown) by a fan (not shown). After a predetermined number of the light-shielding sheets 2 have been collected within the net bag, the net bag is moved to another place for assembly with the lenses 1. During assembly, the light-shielding sheets 2 are individually removed from the net bag, and are put into a lens barrel 3 one at a time.

Some problems are encountered during assembly of aforesaid conventional optical instrument. For example, it is difficult to perform stocktaking and material management of the light-shielding sheets 2, and the light-shielding sheets 2 may be misplaced. Since the light-shielding sheets 2 are lightweight and thin, they are difficult to move using a suction-type apparatus. Conveying is also made difficult by the fact that static electricity is produced on the light-shielding sheets 2 during assembly. Furthermore, since the light-shielding sheets 2 are moved manually or by a suction device, fingerprints or traces of the suction device are formed on surfaces of the light-shielding sheets 2, thereby adversely affecting the light-shielding effect of the light-shielding sheets 2.

### SUMMARY OF THE INVENTION

An object of this invention is to provide a method for fusing a light-shielding sheet onto a transparent body under automatic control.

Another object of this invention is to provide an apparatus for fusing respectively and individually a plurality of light-shielding sheets onto a plurality of transparent bodies, in which the light-shielding sheets form integral portions of a band.

According to an aspect of this invention, a method for fusing a light-shielding sheet onto a transparent body comprises the steps of:

(A) moving the transparent body on a machine bed into a holder unit by suction;

(B) moving the holder unit on the machine bed in a feeding direction;

(C) cooperating with operation of the holder unit so as to move the transparent body on the machine bed to a position under the light-shielding sheet; and

(D) pressing together and heating the light-shielding sheet and the transparent body so as to fuse the light-shielding sheet onto the transparent body, thereby forming an optical lens unit.

According to another aspect of this invention, there is provided an apparatus for fusing respectively a plurality of light-shielding sheets of a band onto a plurality of transparent bodies. The band further has a connecting unit connected integrally to the light-shielding sheets. The apparatus comprises:

a fusion unit including
a base,
a supporting unit disposed on the base,
a movable unit disposed directly above the supporting unit and movable toward and away from the supporting unit, the movable unit including a positioning unit adapted to be moved to engage the band so as to position one of the light-shielding sheets relative to the supporting unit, a heating unit adapted to be moved to engage the band so as to fuse the one of the light-shielding sheets onto a corresponding one of the transparent bodies to thereby form an optical lens unit, and a cutting unit adapted to be moved to cut the band so as to remove the one of the light-shielding sheets from the remaining portion of the band, and
a driving unit for moving the movable unit relative to the supporting unit; and

a plurality of holders, each of which is adapted to receive one of the transparent bodies and is movable onto the supporting unit of the fusion unit.

As such, the light-shielding sheets may be automatically fused to the transparent bodies. This enhances the quality of the optical lens units, and increases the rate of which the light-shielding sheets are fused to the transparent bodies.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is an exploded sectional view of a conventional optical instrument;

FIG. 2 is a schematic top view of the preferred embodiment of an apparatus for fusing respectively a plurality of light-shielding sheets of a band onto a plurality of transparent bodies according to this invention;

FIG. 3 is a sectional view taken along line 3-3 in FIG. 2;

FIG. 4 is a schematic view illustrating intermittent rotation and intermittent vertical reciprocal movement of a rotating member of the preferred embodiment;

FIG. 5 is a sectional view taken along line 5-5 in FIG. 2;

FIG. 6 is a sectional view taken along line 6-6 in FIG. 2;

FIG. 7 is a schematic view of a suction unit of the preferred embodiment;

FIG. 8 is a schematic fragmentary sectional view of a fusion unit of the preferred embodiment;

FIG. 9 is a schematic fragmentary top view of the band processed by the apparatus;

FIG. 10 is a sectional view of an optical lens unit formed from one of the light-shielding sheets and one of the transparent bodies; and

FIGS. 11A, 11B, 11C, 11D, 11E, 11F, 11G, and 11H are schematic views illustrating operation of the fusion unit of the preferred embodiment.

### DETAILED DESCRIPTION OF THE PREFERRED EMBODIMENT

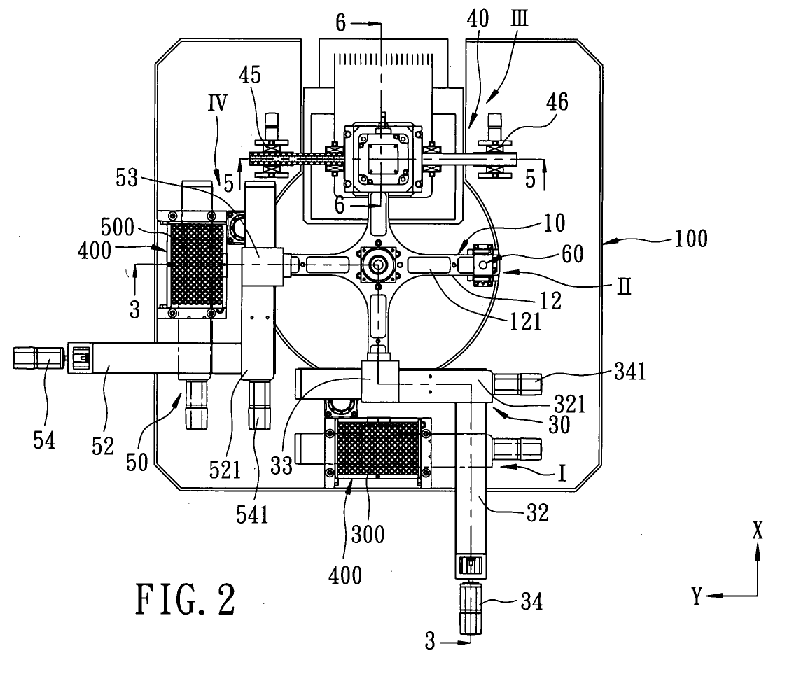

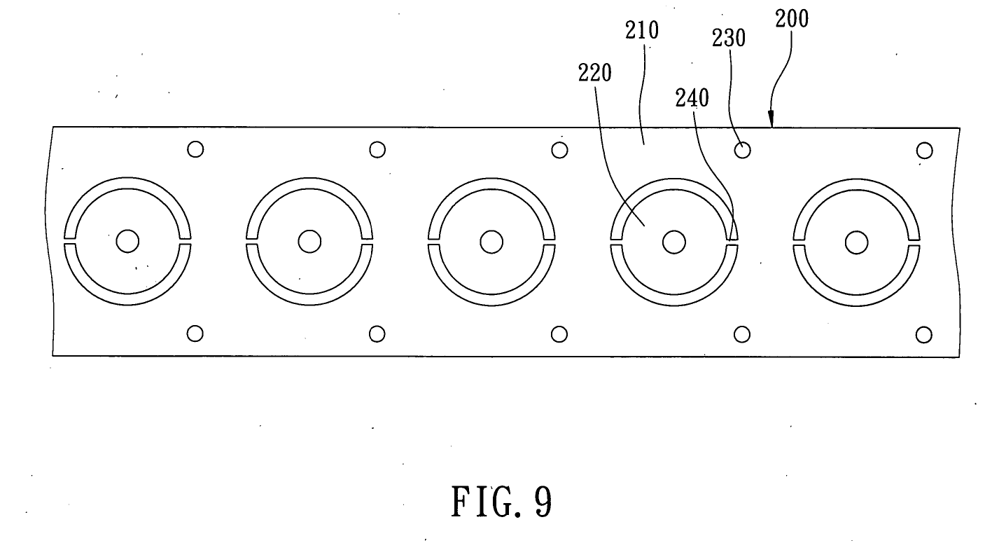

Referring to FIGS. 2, 3, and 9, the preferred embodiment of an apparatus for fusing respectively a plurality of light-shielding sheets 220 of a unitary band 200 onto a plurality of transparent bodies 300 includes a machine bed 100, a rotating unit 10, a cam unit 20 for driving the rotating unit 10, a suction unit 30, a fusion unit 40, a removing unit 50, and a holder unit consisting of four equidistant holders 60. The units 10, 20, 30, 40, 50 are disposed on the machine bed 100. The suction unit 30 and the fusion unit 40 are located to two opposite sides of the rotating unit 10. The holders 60 are disposed on the rotating unit 10.

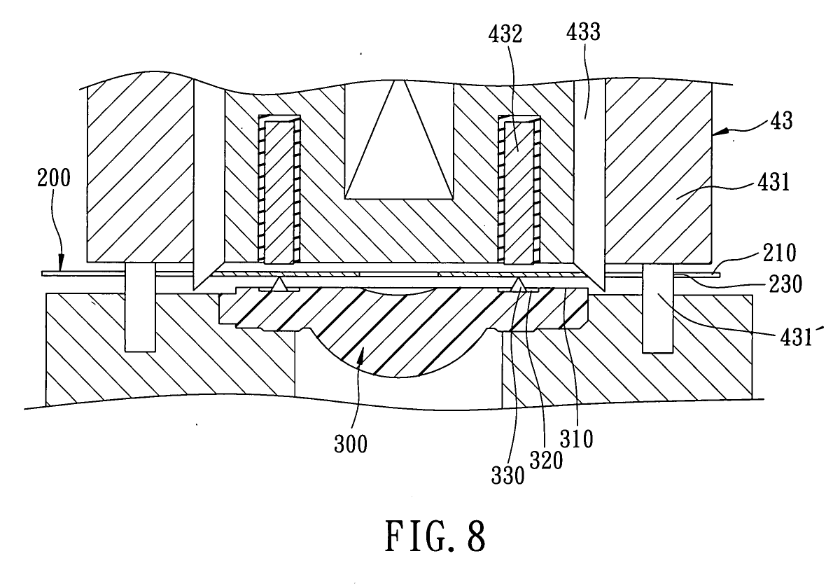

The band 200 is made by blending polyester with carbon black, and has a connecting unit 210 that is connected integrally to the light-shielding sheets 220 such that the light-shielding sheets 220 are arranged along a longitudinal direction of the band 200. The connecting unit 210 is formed with a plurality of positioning holes 230, and a plurality of sheet-connecting strips 240 for connection with the light-shielding sheets 220. The light-shielding sheets 220 are configured as rings. The transparent bodies 300 are optical lenses, and are made of a plastic material. As best shown in FIG. 8, each of the transparent bodies 300 has a surface 310, a plurality of cavities 320 formed in the surface 310, and a plurality of integral projections 330 disposed respectively in the cavities 320. The transparent bodies 300 are received within a receiving tray 400 such that the surfaces 310 face upwardly.

The rotating unit 10 includes a bottom seat 11 movable vertically within the machine bed 100, and a cross-shaped rotating member 12 rotatable intermittently on the bottom seat 11 about a vertical axis in a feeding direction (counterclockwise). The rotating member 12 has four angularly equidistant support arms 121, and stops for a predetermined time period after each 90° rotation. The holders 60 are disposed respectively and fixedly on radial outer ends of the support arms 121.

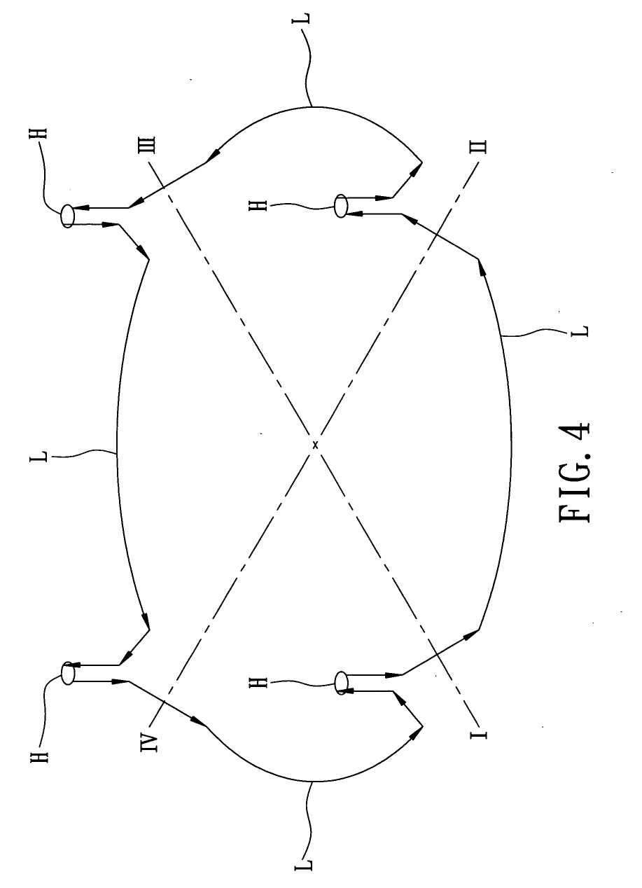

With additional reference to FIG. 4, the cam unit 20 drives the rotating member 12 to move vertically between a high position (H) and a low position (L) during each rotation interval of the rotating member 12.

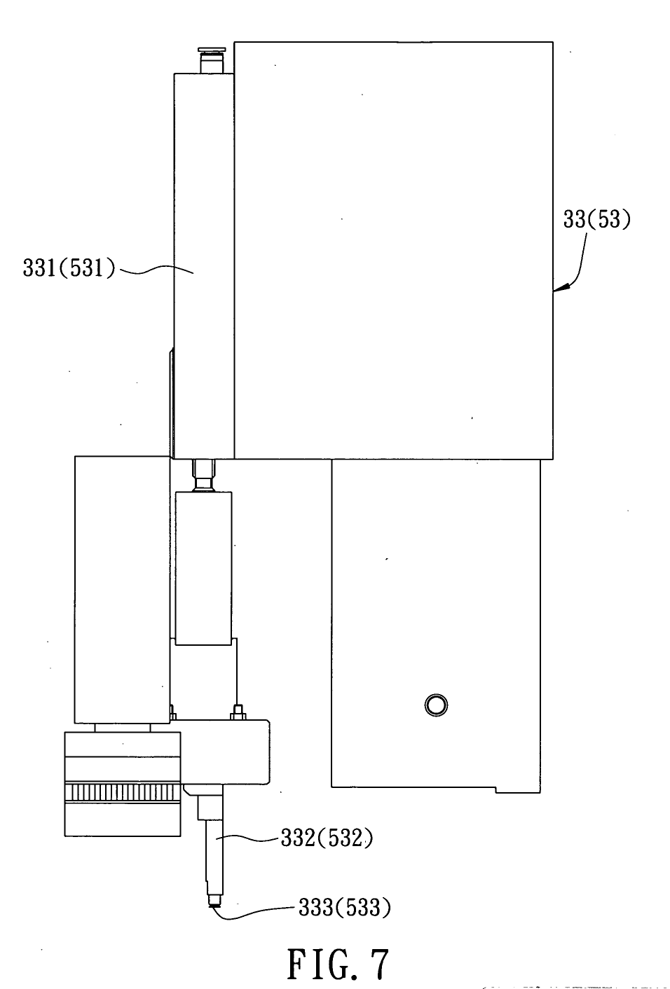

The suction unit 30 is disposed at a first workstation (I), and includes a first fixed seat 31, a horizontal first guide rail 32, a horizontal second guide rail 321, a first supporting member 33, a first driving member 34, and a second driving member 341. The first fixed seat 31 is fixed on a top surface of the machine bed 100. The first guide rail 32 is disposed fixedly on the first fixed seat 31, and extends along a first direction (X) (see FIG. 2). The second guide rail 321 is disposed movably on the first guide rail 32, and extends along a second direction (Y) perpendicular to the first direction (X). The first supporting member 33 is disposed movably on the second guide rail 321. The first driving member 34 is operable to move the second guide rail 321 along the first guide rail 32. The second driving member 341 is operable to move the first supporting member 33 along the second guide rail 321. With additional reference to FIG. 7, the suction unit 30 further includes a first driving cylinder 331, a first operating rod 332, and a first suction nozzle 333. The first operating rod 332 is driven by the first driving cylinder 331 to move vertically relative to the first supporting member 33. The first suction nozzle 333 is disposed on a lower end of the first operating rod 332, and is adapted to move one of the transparent bodies 300 into the corresponding holder 60.

An idle second workstation (II) is disposed behind the first workstation (I) along the feeding direction.

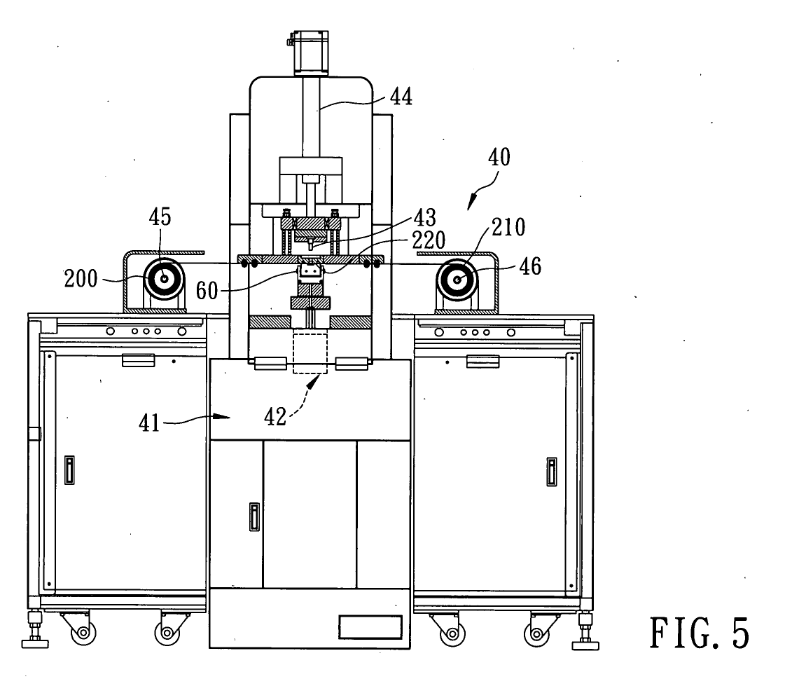

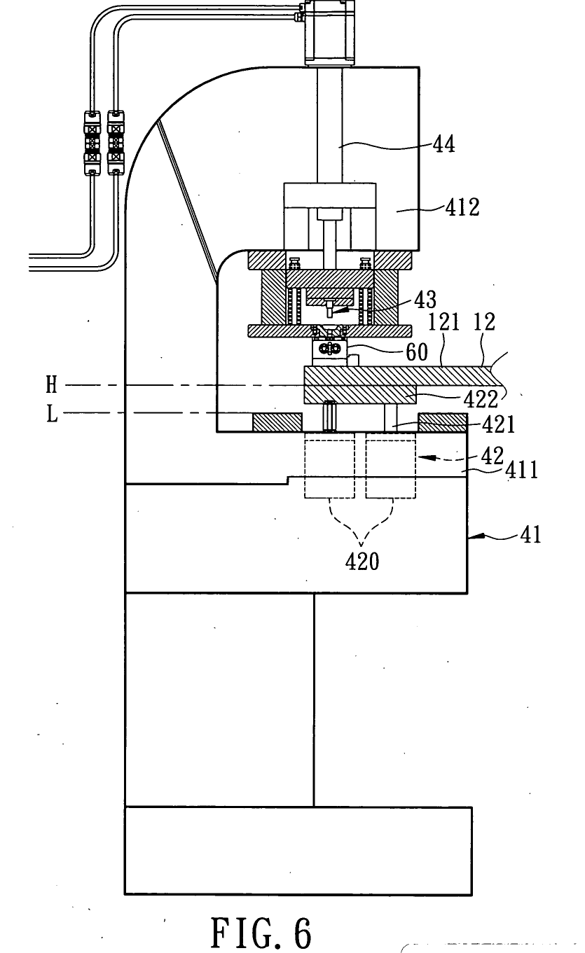

With additional reference to FIGS. 5 and 6, the fusion unit 40 is disposed at a third workstation (III) that is located behind the second workstation (II) along the feeding direction. The fusion unit 40 includes a base 41, a supporting unit 42, a movable unit 43, a driving unit 44, a first spool 45, and a second spool 46.

The base 41 is fixed on the machine bed 100, and has a lower base portion 411 disposed below the rotating member 12, and an upper base portion 412 disposed above the rotating member 12.

The supporting unit 42 is disposed in the base 41, and includes two pressure cylinders 420 and a support block 422 connected fixedly to upper ends of piston rods 421 of the pressure cylinders 420 and abutting against a bottom surface of the rotating member 12 for supporting the radial outer end of one of the support arms 121 thereon.

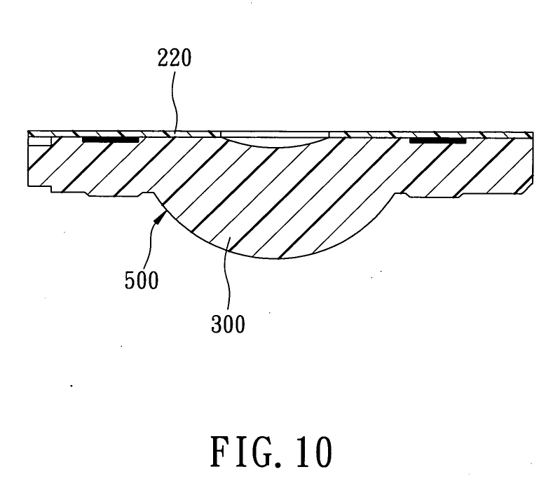

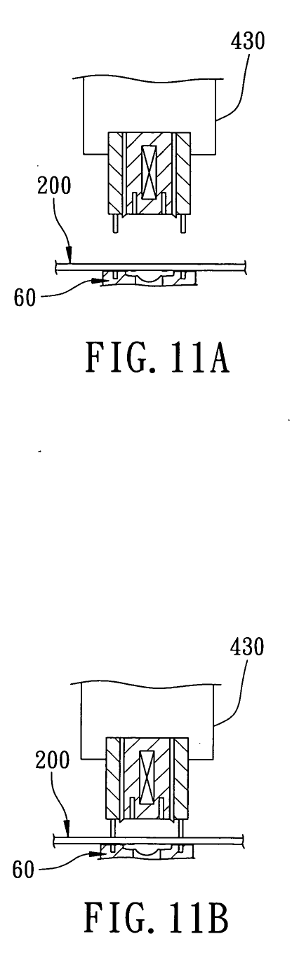

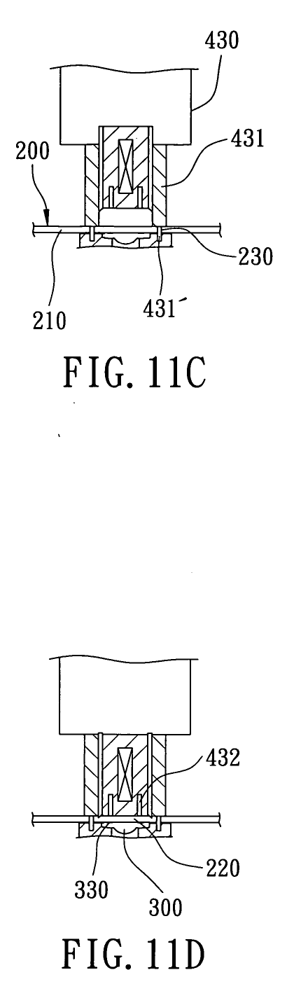

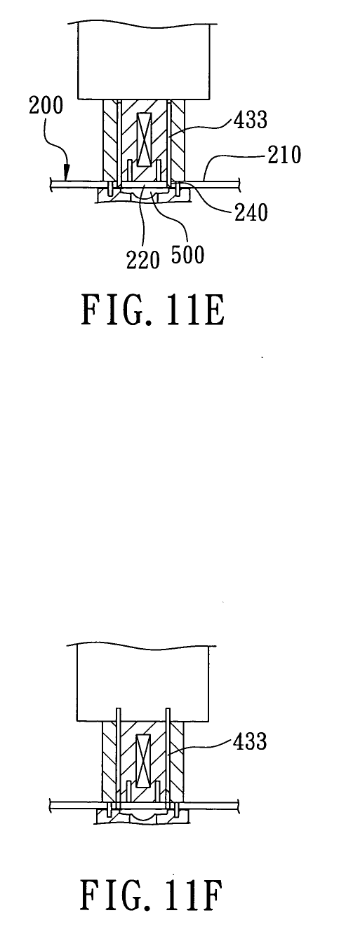

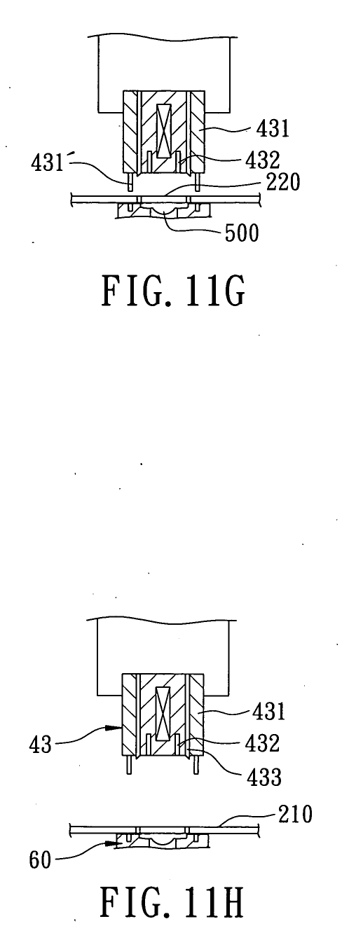

With additional reference to FIG. 8, the movable unit 43 is disposed directly above the supporting unit 42, and is movable toward and away from the supporting unit 42. With additional reference to FIGS. 11A, 11B, 11C, 11D, 11E, 11F, 11G, and 11H, the movable unit 43 includes a movable body 430, a positioning unit consisting of two positioning posts 431, a heating unit 432, and a cutting unit consisting of two cutters 433. The movable body 430 is disposed movably on the upper base portion 412. The positioning posts 431 are connected movably to the movable body 430, and extend downwardly from a bottom surface of the movable body 430. The positioning posts 431 are movable downwardly to press the connecting unit 210 against the corresponding transparent body 300. Each of the positioning posts 431 is formed with a positioning pin 431′ extending downwardly from a bottom surface thereof. The positioning pins 431′ are movable downwardly to engage respectively two of the positioning holes 230 in the band 200 so as to position the corresponding light-shielding sheet 220 relative to the supporting unit 42. The heating unit 432 is connected movably to the movable body 430, and is disposed between the positioning posts 431. The heating unit 432 is movable downwardly to press one of the light-shielding sheets 220 of the band 200 against the projections 330 of the corresponding transparent body 300. When the projections 330 melt due to the indirect contact with the heating unit 432, they fill respectively the cavities 320 in the transparent body 300. Hence, the one of the light-shielding sheets 220 is fused onto the corresponding transparent body 300 to form an optical lens unit 500 (see FIG. 10). Each of the cutters 433 is connected movably to the movable body 430, and is disposed between the heating unit 432 and the corresponding positioning post 431. The cutters 433 are movable downwardly to cut the sheet-connecting strips 240 of the band 200 so as to remove one of the light-shielding sheets 220 from connecting unit 210.

The driving unit 44 is configured as a pressure cylinder, and drives the movable unit 43 to move relative to the support unit 42.

The first and second spools 45, 46 are disposed on the machine bed 100, and are located to two opposite sides of the support unit 42. The first spool 45 is adapted to permit the band 200 to be wounded thereon. The second spool 46 is adapted to permit the connecting unit 210 to be wounded thereon.

The removing unit 50 is disposed at a fourth workstation (IV) that is located behind the third workstation (III) along the feeding direction, and has a structure similar to the suction unit 30, as shown in FIG. 2. The removing unit 50 includes a second fixed seat 51, a horizontal third guide rail 52, a horizontal fourth guide rail 521, a second supporting member 53, a third driving member 54, and a fourth driving member 541. The second fixed seat 51 is fixed on the top surface of the machine bed 100. The third guide rail 52 is disposed fixedly on the second fixed seat 51, and extends along the second direction (Y) (see FIG. 2). The fourth guide rail 521 is disposed movably on the third guide rail 52, and extends along the first direction (X). The second supporting member 53 is disposed movably on the fourth guide rail 521. The third driving member 54 is operable to move the fourth guide rail 521 along the third guide rail 52. The fourth driving member 541 is operable to move the second supporting member 53 along the fourth guide rail 521. The removing unit 50 further includes a second driving cylinder 531, a second operating rod 532, and a second suction nozzle 533, as shown in FIG. 7. The second operating rod 532 is driven by the second driving cylinder 531 to move vertically relative to the second supporting member 53. The second suction nozzle 533 is disposed on a lower end of the second operating rod 532, and is adapted to remove one of the optical lens units 500 from the corresponding holder 60.

Each of the holders 60 is adapted to receive one of the transparent bodies 300, and is rotatable with the rotating member 12 into the first, second, third, and fourth workstations (I, II, III, IV) to align with the suction unit 30, the fusion unit 40, and the removing unit 50.

When the holders 60 are stopped respectively at the first, second, third, and fourth workstations (I, II, III, IV), the rotating member 12 is disposed at the high position (H).

When it is desired to perform a fusing operation by means of the apparatus of this invention, a plurality of receiving trays 400 filled with the transparent bodies 300 are disposed on the machine bed 100 near the suction unit 30, and a plurality of empty receiving trays 400 are disposed on the machine bed 100 near the removing unit 50.

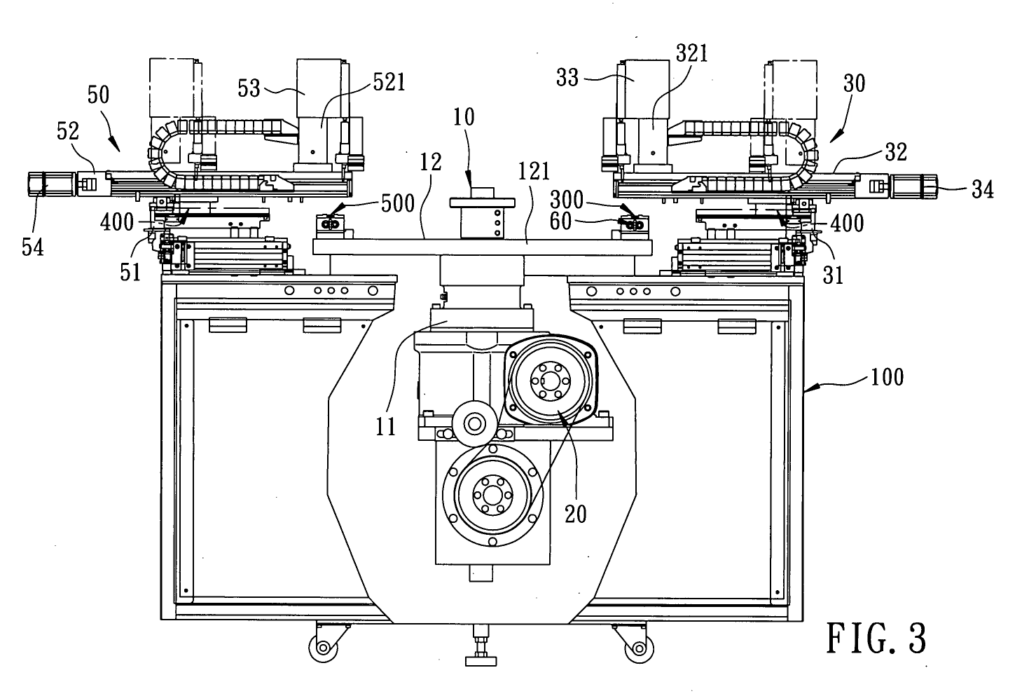

Referring to FIGS. 2 and 3, the preferred embodiment of a method for fusing one light-shielding sheet 220 onto one transparent body 300 according to this invention includes the following steps:

(A) moving the transparent body 300 on the machine bed 100 into the holder unit by suction;

(B) moving the holder unit on the machine bed 100 in the feeding direction;

(C) cooperating with operation of the holder unit so as to move the transparent body 300 on the machine bed 100 to a position under the light-shielding sheet 220;

(D) pressing together and heating the light-shielding sheet 220 and the transparent body 300 so as to fuse the light-shielding sheet 220 onto the transparent body 300, thereby forming one optical lens unit 500; and

(E) removing the optical lens unit 500 from the holder unit.

In the step (A), the first and second driving members 34, 341 are operated so as to move and align the first supporting member 33 with the transparent body 300 to be fused. Subsequently, the first operating rod 332 can be moved downwardly by the first driving cylinder 331 so as to permit the first suction nozzle 333 to attach to the transparent body 300. The first driving cylinder 331 again drives the first operating rod 332 and the attached transparent body 300 to move upwardly. The first and second driving members 34, 341 are operated again to move the transparent body 300 to a position directly above the holder 60 at the first workstation (I). At this time, the first driving member 331 drives the first operating rod 332 to move downwardly to allow for placement of the transparent body 300 into the holder 60.

In the step (B), the rotating member 12 is rotated by 90° to move the holder 60 from the first workstation (I) into the second workstation (II). In the second workstation (II), no operation is performed on the transparent body 300.

In the step (C), the rotating member 12 is rotated by 90° once again to move the holder 60 from the second workstation (II) into the third workstation (III). As such, the holder 60 is moved to the position under the light-shielding sheet 220.

With additional reference to FIGS. 5, 6, 11A, 11B, 11C, 11D, 11E, 11F, 11G, the step (D) includes the substeps:

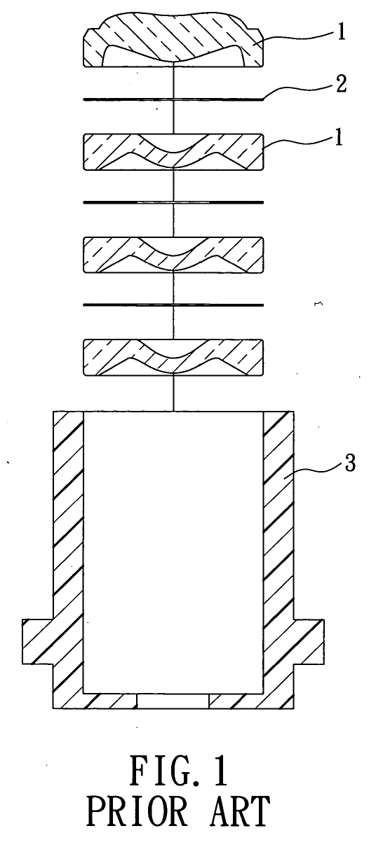

(D1) moving the support block 422 upwardly by the pressure cylinders 420 to abut against the supporting arm 121 extending into the base 41 of the fusion unit 40, and simultaneously moving the positioning posts 431 of the movable unit 43 downwardly so as to press the light-shielding sheet 220 against the transparent body 300 and so as to engage respectively the positioning pins 431′ of the fusion unit 40 with a plurality of the positioning holes 230 in the band 200, thereby positioning the light-shielding sheet 220 on the machine bed 100, as shown in FIG. 1C;

(D2) moving the heating unit 432 of the movable unit 43 downwardly so as to press the light-shielding sheet 220 against the transparent body 300, thereby fusing the light-shielding sheet 220 onto the transparent body 300, as shown in FIG. 1D;

(D3) moving the cutters 433 of the movable unit 43 downwardly so as to cut the band 200 at junctures between the light-shielding sheet 220 and the remaining portion of the band 200, i.e., two sheet-connecting strips 240 flanking the light-shielding sheet 220, thereby removing the light-shielding sheet 220 from the remaining portion of the band 200, as shown in FIG. 11E, to form the optical lens unit 500;

(D4) retracting the cutters 433 into the movable unit 43, as shown in FIG. 11F; and

(D5) removing the positioning posts 431 and the heating unit 432 from the light-shielding sheet 220, as shown in FIG. 11G.

When the movable unit 43 moves upwardly away from the connecting unit 210 to an upper limit position shown in FIG. 11H, the first and second spools 45, 46 are rotated so as to move the next light-shielding sheet 220 to a position under the movable unit 43, thereby allowing for a subsequent fusing operation.

In the step (E), the rotating member 12 is rotated by 90° one more time to move the holder 60 loaded with the optical lens unit 500 from the third workstation (III) into the fourth workstation (IV). Because the second operating rod 532 can be moved vertically by means of the second driving cylinder 531, and because the second supporting member 53 can be moved along the first and second directions (X, Y), the optical lens unit 500 can be attached to and moved by the suction nozzle 533 from the holder 60 onto one receiving tray 400 near the removing unit 50. During each interval of intermittent rotation of the rotating unit 10, each of the holders 60 is moved on the machine bed 100 from the low position to the high position, and subsequently from the high position to the low position.

The method of this invention has the following advantages:

(1) Since the light-shielding sheets 220 are connected integrally to the connecting unit 210 of the band 200, and since the band 200 is wound on the first spool 45, stocktaking and material management of the light-shielding sheets 220 can be easily performed.

(2) Since the light-shielding sheets 220 are cut to separate from the connecting unit 210 of the band 200 after they are fused respectively onto the transparent bodies 300, the disadvantages associated with the assembly process of the conventional optical lens unit of FIG. 1, including difficulties in moving the light-shielding sheets 220 by suction, and including formation of fingerprints or traces of a suction device on surfaces of the light-shielding sheets 220, are eliminated.

(3) The apparatus is a fully automatic machine. Thus, the quality of the optical lens units 500 can be enhanced. Furthermore, the rate of which the light-shielding sheets 220 are fused to the transparent bodies 300 is increased.

It is noted that the projections 330 are optional because the light-shielding sheets 220 can still be fused onto the transparent bodies 330 without the use of the projections 330.

With this invention thus explained, it is apparent that numerous modifications and variations can be made without departing from the scope and spirit of this invention. It is therefore intended that this invention be limited only as indicated by the appended claims.

We claim:

1. A method for fusing a light-shielding sheet onto a transparent body, comprising the steps of:
(A) moving said transparent body into a holder unit by suction;
(B) moving said holder unit in a feeding direction;
(C) cooperating with operation of said holder unit so as to move said transparent body to a position under said light-shielding sheet; and
(D) pressing together and heating said light-shielding sheet and said transparent body so as to fuse said light-shielding sheet onto said transparent body, thereby forming an optical lens unit.

2. The method as claimed in claim 1, further comprising a step (E), after the step (D), of removing said optical lens unit from said holder unit.

3. The method as claimed in claim 2, wherein the step (A) includes moving said transparent body into one of a plurality of equidistant holders of said holder unit by suction, which are disposed on a rotating unit, and the step (B) includes intermittently rotating said rotating unit and, thus, said holders in said feeding direction.

4. The method as claimed in claim 3, wherein the step (D) includes the substeps:
(D1) engaging respectively a plurality of positioning pins of a fusion unit with a plurality of positioning holes in a unitary band including said light-shielding sheet, thereby positioning said light-shielding sheet;
(D2) moving a heating unit of a movable unit of said fusion unit so as to press said light-shielding sheet against said transparent body, thereby fusing said light-shielding sheet onto said transparent body; and
(D3) moving a cutting unit of said movable unit of said fusion unit toward said transparent body so as to cut said band at junctures between said light-shielding sheet and the remaining portion of said band, thereby removing said light-shielding sheet from the remaining portion of said band.

5. The method as claimed in claim 3, wherein the step (B) includes operating a cam unit to move each of said holders from a low position to a high position, and subsequently from said high position to said low position during each interval of intermittent rotation of said rotating unit.

6. The method as claimed in claim 1, wherein said transparent body is made of a plastic material, and said light-shielding sheet is made by blending polyester with carbon black.

7. An apparatus for fusing respectively a plurality of light-shielding sheets of a band onto a plurality of transparent bodies, the band further having a connecting unit connected integrally to the light-shielding sheets, said apparatus comprising:
a fusion unit including
a base,
a supporting unit disposed on said base,
a movable unit disposed directly above said supporting unit and movable toward and away from said supporting unit, the movable unit including a positioning unit adapted to be moved to engage the band so as to position one of the light-shielding sheets relative to said supporting unit, a heating unit adapted to be moved to engage the band so as to fuse the one of the light-shielding sheets onto a corresponding one of the transparent bodies to thereby form an optical lens unit, and a cutting unit adapted to be moved to cut the band so as to remove the one of the light-shielding sheets from the remaining portion of the band, and
a driving unit for moving said movable unit relative to said supporting unit; and
a plurality of holders, each of which is adapted to receive one of the transparent bodies and is movable onto said supporting unit of said fusion unit.

8. The apparatus as claimed in claim 7, wherein said fusion unit further includes a pair of first and second spools located to two sides of said supporting unit of said fusion unit, said first spool being adapted to permit the band to be wounded thereon, said second pool being adapted to permit the connecting unit of the band to be wounded thereon.

9. The apparatus as claimed in claim 8, further comprising:
a machine bed, said base of said fusion unit being fixed on said machine bed, said first and second pools being disposed on said machine bed;
a rotating unit including a bottom seat movable vertically within said machine bed, and a rotating member rotatable on said bottom seat in a feeding direction, said holders being disposed fixedly on said rotating member; and
a cam unit for moving said bottom seat of said rotating unit and, thus, each of said holders intermittently and vertically between a high position and a low position.

10. The apparatus as claimed in claim 9, further comprising a suction unit that is disposed in front of said fusion unit along said feeding direction and that includes:
a first fixed seat fixed on said machine bed;
a horizontal first guide rail disposed fixedly on said first fixed seat and extending along a first direction;
a horizontal second guide rail disposed movably on said first guide rail and extending along a second direction perpendicular to said first direction;
a first supporting member disposed movably on said second guide rail;
a first driving member operable to move said second guide rail along said first guide rail;
a second driving member operable to move said first supporting member along said second guide rail;
a first operating rod disposed movably on said first supporting member;
a first driving cylinder for driving said first operating rod to move vertically relative to said first supporting member; and
a first suction nozzle disposed on an end of said first operating rod and adapted to move one of the transparent bodies into a corresponding one of said holders.

11. The apparatus as claimed in claim 10, further comprising a removing unit that is disposed behind said fusion unit along said feeding direction and that includes:
a second fixed seat fixed on said machine bed;
a horizontal third guide rail disposed fixedly on said second fixed seat and extending along said second direction;
a horizontal fourth guide rail disposed movably on said third guide rail and extending along said first direction;
a second supporting member disposed movably on said fourth guide rail;
a third driving member operable to move said fourth guide rail along said third guide rail;
a fourth driving member operable to move said second supporting member along said fourth guide rail;
a second operating rod disposed movably on said second supporting member;
a second driving cylinder for driving said second operating rod to move vertically relative to said second supporting member; and
a second suction nozzle disposed on an end of said second operating rod and adapted to remove said optical lens unit from the corresponding one of said holders.

12. The apparatus as claimed in claim 9, wherein said rotating member has a bottom surface, said supporting unit of said fusion unit including at least one pressure cylinder and abutting against said bottom surface of said rotating member.
